(19) United States
(12) Patent Application Publication
(10) Pub. No.: US 2022/0166892 A1
(43) Pub. Date: May 26, 2022

(54) PRINTING APPARATUS WITH MECHANICAL ENGAGEMENT INTERFACE

(71) Applicant: Hewlett-Packard Development Company, L.P., Spring, TX (US)

(72) Inventor: Justin Yang, Boise, ID (US)

(73) Assignee: Hewlett-Packard Development Company, L.P., Spring, TX (US)

(21) Appl. No.: 17/311,792

(22) PCT Filed: Aug. 15, 2019
(86) PCT No.: PCT/US2019/046612

§ 371 Date: Jun. 8, 2021

(51) Int. Cl. H04N 1/00; G06F 3/0362; G06F 3/0485; G06F 3/0338; G06F 3/0354

(52) U.S. Cl. CPC H04N 1/00397; G06F 3/0362; H04N 1/00413; H04N 1/00514; G06F 3/0338; G06F 3/03547; G06F 3/0485

(57) ABSTRACT

An apparatus, and related methods and machine readable programs are disclosed herein for control of a device, such as a printing apparatus. An implementation of a printing apparatus includes a hand engagement interface including a manual actuator to receive a mechanical user input coupled to visual feedback circuitry. A processor circuit is coupled to the manual actuator and the visual feedback circuitry. The processor circuit executes machine readable instructions to detect mechanical user input to the manual actuator, and responsive to the mechanical user input, render a dynamic display of selectable indicia to a user via the visual feedback circuitry. The user is able to execute a control function of the printing apparatus by scrolling through and selecting an indicium from the selectable indicia.

### BACKGROUND

Printing devices are typically provided with a variety of different ways to interface with the printing device, such as buttons, simple screens displaying text, as well as wireless connectivity. The present disclosure improves on the state of the art, as set forth herein.

### BRIEF DESCRIPTION OF FIGURES

Various examples may be more completely understood in consideration of the following detailed description in connection with the accompanying drawings, in which:

FIG. 1A is an isometric view of a printing apparatus in accordance with the disclosure.

FIG. 1B is a schematic perspective view of a portion of the printing apparatus of FIG. 1A illustrating a first implementation of a mechanical engagement interface in accordance with the present disclosure;

FIG. 2A is an isometric view of a further printing apparatus in accordance with the disclosure.

FIG. 2B is a schematic perspective view of a portion of the printing apparatus of FIG. 2A illustrating a further implementation of a mechanical engagement interface in accordance with the present disclosure;

FIG. 3 is a schematic perspective view of still a further implementation of a mechanical engagement interface in accordance with the present disclosure;

FIG. 4 is a schematic view of an implementation of a mechanical engagement interface using a linear slide in accordance with the present disclosure; and

FIG. 5 is a schematic view of an implementation of a mechanical engagement interface using a touch pad in accordance with the present disclosure.

While various examples discussed herein are amenable to modifications and alternative forms, aspects thereof have been shown by way of example in the drawings and will be described in detail. It should be understood, however, that the intention is not to limit the disclosure to the particular examples described. On the contrary, the intention is to cover all modifications, equivalents, and alternatives falling within the scope of the disclosure including aspects defined in the claims. In addition, the term “example” as used throughout this application is by way of illustration, and not limitation.

### DETAILED DESCRIPTION

Aspects of the present disclosure are believed to be applicable to a variety of different types of apparatuses, systems and methods using manual interfaces with various displays. The present disclosure specifically illustrates examples of printing devices having displays with a mechanical input that permits finer user control that previous systems.

Accordingly, in the following description various specific details are set forth to describe specific examples presented herein. Other examples and/or variations of these examples may be practiced without all the specific details given below. In other instances, particular features have not been described in detail so as not to obscure the description of the examples herein. For ease of illustration, the same reference numerals may be used in different diagrams to refer to the same elements or additional instances of the same element. Also, although aspects and features may in some cases be described in individual figures, it will be appreciated that features from one figure or example may be combined with features of another figure or example even though the combination is not explicitly shown or explicitly described as a combination.

The disclosure provides various implementations of printing devices and associated methods and machine readable programs, wherein the printing apparatus including a hand engagement interface including a manual actuator coupled to visual feedback circuitry, and a processor circuit coupled to the manual actuator and the visual feedback circuitry. Manual input from a user can be detected by way of the manual actuator, and responsive to the manual user input, selectable indicia is displayed via the visual feedback circuitry.

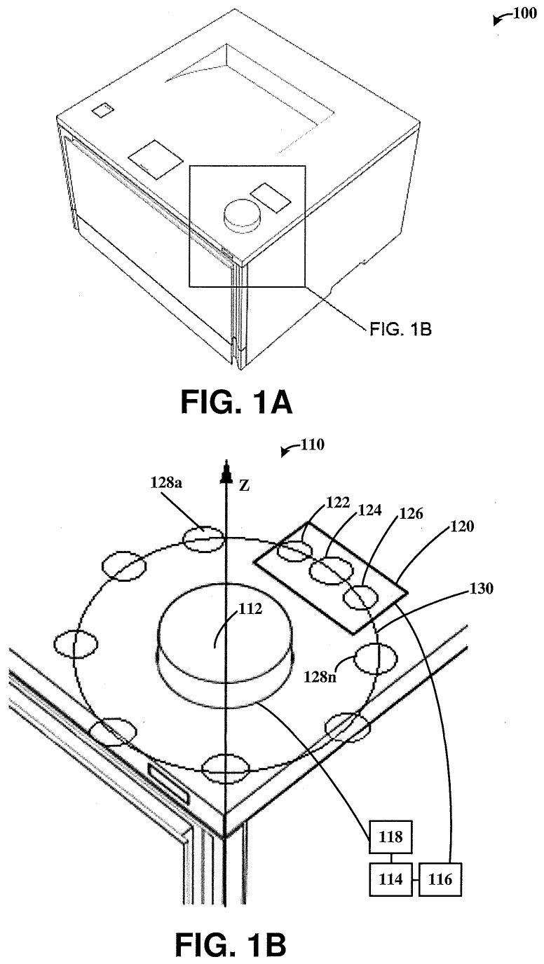

For purposes of illustration, and not limitation, FIG. 1A presents an illustrative embodiment of a printing apparatus 100 in accordance with the present disclosure. FIG. 1B presents a perspective schematic diagram of a hand engagement interface 110 of printing apparatus 100 including a manual actuator 112 coupled to visual feedback circuitry 118 by way of a processor circuit 114. The manual actuator 112 is to receive a mechanical user input from a user. The processor circuit 114 executes machine readable instructions disposed in memory 116 to detect a mechanical user input to the manual actuator 112, which may be, for example, by way of rotation, sliding, pressing, and the like. Responsive to the mechanical user input by the user, the processor circuit 114 is programmed to execute machine readable instructions to dynamically render an image on a display 120 that can include user selectable indicia 122, 124 and 126 by way of the visual feedback circuitry 118. The user is able to execute a control function of the printing apparatus by scrolling through and selecting an indicium from the selectable indicia 122, 124, 126.

As illustrated in FIG. 1B, the manual actuator 112 is presented in the form of a rotatable dial. The actuator 112 may be rotated, and its relative position may be detected, for example, by coupling the dial to a rotational potentiometer, or to a circuit board including a circuit that may be closed when the rotatable dial is in a particular rotational position. Indicia (122, 124, 126) may be scrolled across the screen in response to user input to the dial.

As illustrated, the processor circuit 114 executes machine readable instructions to scroll the selectable indicia 122, 124, 126 across the display screen along a curved path responsive to rotation of the rotatable mechanical dial 112. When executed by the processor circuit 114, the machine readable instructions may cause the selectable indicia, such as in the form of various unique selectable indicia 128a . . . 128n, to appear in a predetermined location along a virtual path 130, for example, as illustrated in FIG. 1B. The virtual path 130 may be a circle, ellipse, rectangle, triangle, serpentine or any other desired shape. When provided in the form of a circle, the virtual path 130 can effectively permit a user to experience the scrolling of the indicia as if they were rotating a large dial with selectable indicia 128a . . . 128n in predetermined locations along the circumference of the virtual circle. The machine readable instructions can cause each indicia 128a-n can be assigned to a virtual location along the virtual circle 130. The spacing between the indicia 122, 124, 126, 128 a-n may be fixed, or may be varied. If desired, the machine readable instructions may cause a particular indicia 124 to be selectable, for example, when it is positioned in a predetermined part of the display 120, such as at the center of the display. As illustrated, the selectable indicia 124 can be visually enlarged when displayed in the predetermined part of the display, and adjacent indicia 122, 126 can be displayed as being relatively smaller. This can communicate to a user that the enlarged indicium 124 is the selectable indicium that a user may select in various ways, described in further detail below.

If desired, the scrolling of the indicia 122, 124, 126, 128a-n may be performed in relative synchronization with the rotational displacement of the rotatable dial. In some implementations, this synchronization may be a 1:1 angular synchronization, such that the relative angular displacement of indicia along the virtual path 130 is the same as the angular displacement of the dial. For coarser control, the relative angular displacement of the indicia as displayed on the display 120 can be larger than the relative angular displacement of the dial. If desired, the virtual path 130 can include multiple virtual layers of selectable indicia, by providing a plurality of stacked virtual paths. For example, more than one virtual circle of selectable indicia can be provided, such as virtual circles of indicia having twelve indicia each. When a user scans through all twelve indicia, a second virtual circle can start to be displayed with a second set of indicia, and so forth until a predetermined number of virtual paths have been displayed. By way of further example, to provide finer control, a user may rotate the dial by a relatively larger angle to cause indicia to scroll across the display. Thus, in the example of a circular virtual path 130, two, three, four, or more 360 degree rotations of the rotatable dial may be used in order to traverse the full extent of the virtual path.

In further accordance with the disclosure, as illustrated in FIG. 1A, the device 100 can include machine readable instructions that permit a user to select an enlarged indicia, or an indicium that is otherwise differentiated from the other indicia. This selection by the user of a particular indicium can be effectuated, for example, by permitting the rotatable mechanical dial to be linearly displaceable along a direction that is parallel to a central rotational axis Z thereof as indicated by the double-headed arrow illustrated in FIG. 1B. Thus, a user can depress/push, pull, or otherwise actuate the dial to select the indicia, for example, to execute a printer control function. The processor circuit 114 therefore executes the appropriate machine readable instructions to interpret depression of the rotatable mechanical dial as mechanical user input.

In some implementations, the display screen 120 is not responsive to touch input. This is because the display screen 120 is principally used to scroll a listing or menus and submenus of selectable indicia. Selection of an individual indicium can be performed in such instances, for example, by pressing the rotatable dial down, pressing another button or actuator, or the like. However, if desired, in some other implementation, the act of selection of an indicium that is displayed on the display 120 can be performed by touching the display 120 in the area of the screen where the indicium is located, or at another predetermined location on the screen. By being able to scroll the indicia across the display screen 120, and permitting a user to select a sub menu, for example, after selecting the indicia that in turn includes a further listing of indicia, a small display screen 120 can be used to scroll and select among an extremely large number of indicia without requiring a large display screen 120. Thus, the display screen can be, in some implementation, between about one and about three inches across, yet permit the user to select among dozens or even hundreds of indicia. In various examples, a larger sized displays can be used, as desired.

The display 120 can include any suitable type of display (holographic and the like), and is not limited to a flat panel display that produces a two-dimensional visual image. For example, additionally or alternatively the hand engagement interface can produce haptic feedback to inform a user of various events, such as changing from one indicium to the next by emitting a sound or vibration, and the like. It will be appreciated however that the display 120 can be an active display that is not preconfigured to display particular icons, but the display 120 can be configured to display an image in any location on its surface. This can be considered to be in contrast to a simplified display that has icons formed into it that light up when a particular circuit is closed. Thus the system overall is reconfigurable and programmable to display different indicia in different locations of the screen. As further displayed in FIG. 1B, the manual actuator, illustrated as a rotatable mechanical dial, can be physically located or otherwise disposed near the display screen 120 to permit a user's hand eye coordination to facilitate use of the hand engagement interface 110.

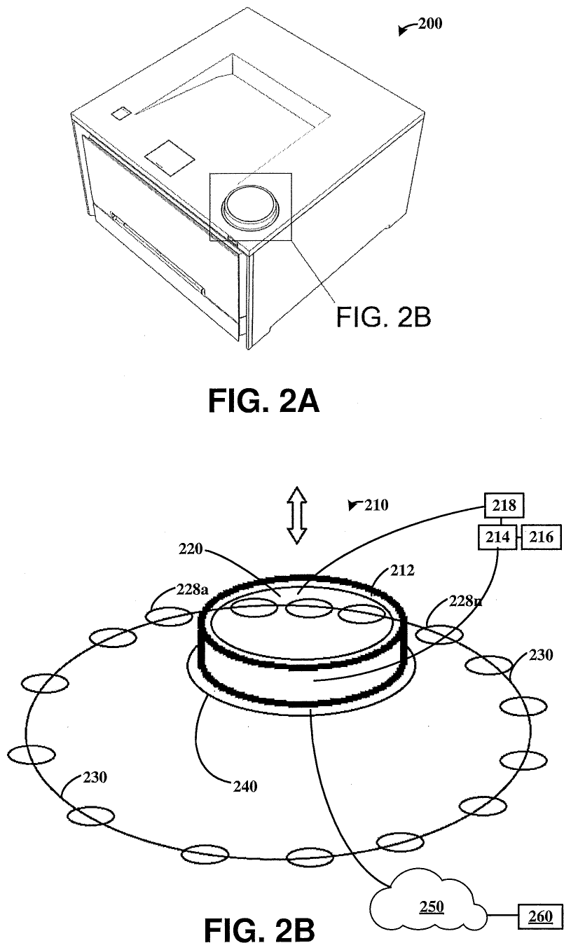

For purposes of further illustration, FIG. 2A presents an illustrative embodiment of a further printing apparatus 200 in accordance with the present disclosure. FIG. 2B presents a perspective schematic diagram of a further example of a hand engagement interface 210 of printing apparatus 200

As illustrated in FIG. 2B, a hand engagement interface 210 can be provided that provides a display screen 220 located within a selectable annularly shaped dial 212 that at least partially surrounds the display 220. The dial 212 may be a mechanical ring shaped dial that rotates about a stationary display 220. Alternatively, the dial 212 may include an annularly shaped touch sensitive surface that senses a swiping movement along its circumferential extent, but remains physically stationary. In other implementations, the display screen 220 can rotate physically with the dial 212, but the processor circuit 214 can execute machine readable instructions to continuously update the display 220 with an image that appears to not be rotating with respect to the user's point of view. As further illustrated, the processor circuit 214 can execute machine readable code to cause the selectable indicia 228a-n to traverse a virtual path 230 of any desired shape.

If desired, the hand engagement interface 210 can be provided with further visual feedback circuitry that can actuate, for example, a lighting beacon 240, such as in the form of a LED light ring, or similar device that can be used to inform a user from a distance that the printing device needs attention such as for maintenance. By way of further example, the processor circuit 214 can execute machine readable code that causes the lighting beacon 240 to illuminate in a unique predetermined color and/or blinking pattern to permit a user to select the printing device from a number of closely located printing devices, such as a room that may include many networked printers. The printing device can be connected by way of a private or public network 250 to a user's handheld device, wherein the processor circuit 214 executes machine readable code to cause the lighting beacon and a portion of a display screen of a user's portable computing device 260, such as smart phone, to illuminate in the same color and/or pattern to permit the user to identify the correct printer from which to retrieve their print job. For example, a user may need to first identify the printer and then provide a further input to cause the print job to print for security purposes. This can be performed in any desired manner, such as by inputting a code into the printer or by placing the user's portable computing device in proximity with the printing device.

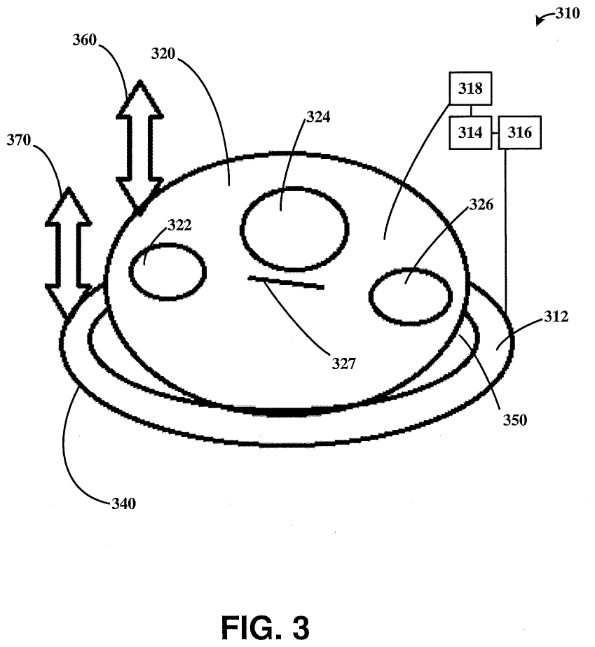

In accordance with a further implementation, FIG. 3 presents a further implementation of a hand engagement interface 310 in accordance with the present disclosure. Hand engagement interface 310 includes a manual actuator 312 presented in the form of a rotatable ring, for example. A display screen 320 is also provided that may display visual indicia 322, 324, 326. Indicia 322, 324, 326 or any other indicia described herein may include an image and/or textual indicia 327. Display 320 and the manner in which indicia is rendered thereon may be generally similar to that of display 120 of FIG. 1B. Thus, actuator 312 can be actuated by rotation to scroll indicia across the screen 320. Selection of a particular indicium can be accomplished, for example, by applying downward pressure to actuator 312 along direction 370, or if desired applying downward pressure to the structure supporting the screen 320 along direction 360. However, as desired, display 320 can be mounted at an angle as illustrated for ease of view by a user, or display 320 can be mounted on a pivot that permits the display to tilt upwardly and downwardly as desired to permit a user to set the display 320 at a desired viewing angle.

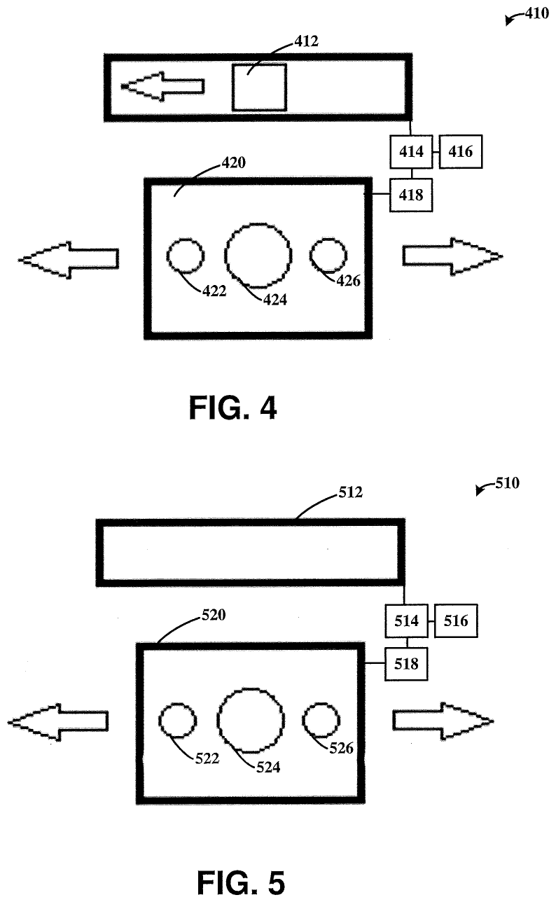

In further accordance with the disclosure, FIG. 4 illustrates a further example of a hand engagement interface 410 in accordance with the present disclosure. Hand engagement interface 410 includes a manual actuator 412 presented in the form of a linear slide or slidable switch that may be slid from side to side along a straight or curved path, as desired. A display screen 420 can also be provided that may display visual indicia 422, 424, 426. Display 420 and the manner in which indicia is rendered thereon may be generally similar to that of display 120 of FIG. 1B. The processor circuit 414 associated with the interface 410 executes the machine readable instructions to cause the visual feedback circuitry 418 to scroll selectable indicia 422, 424, 426 across display screen 420. The processor circuit 414 may perform this scrolling operation in synchronization with corresponding linear sliding displacement of the mechanically slidable switch on either a one to one basis, wherein distance traversed by the switch is the same as distance traversed by an indicia across the screen, or relative displacement of the manual actuator 412 may produce a proportionately larger or smaller displacement of indicia 422, 424, 426 across the display screen 420. If desired, the manual actuator 412 may be spring-biased to remain in a central portion of a mechanical switch, and sliding and holding the actuator 412 against the bias of the spring to the left or right (or other relative opposing directions, depending on the physical orientation of the slide, such as up and down) can cause the processor circuit 414 to execute machine readable code to cause the indicia to scroll across the display 420 to the left or to the right, respectively (or along another relative direction) wherein mechanically releasing the actuator 412 permits it to bias to a starting location, and causing the scrolling of the indicia to cease. If desired, the relative linear displacement of actuator 412 can be proportional to the speed at which the indicia scroll across the display, such that a larger displacement can cause faster scrolling.

If desired, with continuing reference to the example of FIG. 4, the processor circuit can execute machine readable code to cause the indicia to traverse a linear path across the display or a curved path, as desired. As with preceding examples, if desired, the processor circuit can execute machine readable code to cause the indicia to effectively traverse a virtual path in a closed loop or along an open path such as a straight or curved line.

FIG. 5 illustrates yet a further example of a hand engagement interface 510 in accordance with the present disclosure. Hand engagement interface 510 includes a manual actuator presented in the form of a touch pad 512 (or otherwise touch sensitive surface) that a user may tap or swipe from side to side along a straight or curved path, as desired. A display screen 520 is also provided that may display visual indicia 522, 524, 526. Display 520 and the manner in which indicia is rendered thereon may be generally similar to that of display 120 of FIG. 1B. The processor circuit 514 associated with the interface 510 executes the machine readable instructions to cause the visual feedback circuitry 518 to scroll selectable indicia 522, 524, 526 across display screen 520. The processor circuit 514 may perform this scrolling operation in synchronization with corresponding linear sliding contact of a user's fingertip along the touch pad interface 512. Selection of a particular indicia can be accomplished, for example, by tapping the touch pad interface once, or by holding a user's fingertip against it for a predetermined period of time, such as one, two or three seconds. The distance traversed by a user's fingertip across the touch pad interface 512 can be on a one to one basis, wherein distance traversed by a user's fingertip can be the same as distance traversed by an indicia across the screen. Or relative displacement of a user's fingertip across the interface 512 may produce a proportionately larger or smaller displacement of indicia 522, 524, 526 across the display screen 520.

If desired, with continuing reference to the example of FIG. 5, the processor circuit 514 can execute machine readable code to cause the indicia to traverse a linear path across the display 520 or a curved path, as desired. As with preceding examples, if desired, the processor circuit 514 can execute machine readable code to cause the indicia to effectively traverse a virtual path in a closed loop or along an open path such as a straight or curved line. By way of further example, if desired, the touch pad interface can occupy a surface area such as a square or other shape and the processor circuit can execute machine readable code to cause indicia to scan across the screen along two dimensions, for example, wherein a diagonal swipe can cause relative diagonal movement of elements across the screen, as desired.

In further accordance with the disclosure, with respect to any example herein, the processor circuit can execute machine readable instructions to permit a user to customize display settings of selectable indicia. For example, machine readable instructions may permit a user to delete certain indicia, make certain indicia not visible, rearrange menus, and the like. Custom user menus can be provided and synchronized with an individual user's account. This permits a printing device in accordance with the present disclosure to download a file by way of a network or by directly communicating with a user's mobile user device (such as a smart phone) to load a user's preferences to permit them to effectively navigate the same menus that they have customized on many different printing devices.

It should be noted that the present disclosure can be implemented by machine readable instructions and/or in a combination of machine readable instructions and hardware, such as using application specific integrated circuits (ASIC), a programmable logic array (PLA), including a field-programmable gate array (FPGA), or a state machine deployed on a hardware device, a general purpose computer or any other hardware equivalents, such as computer readable instructions pertaining to the method(s) discussed above can be used to cause a hardware processor to perform the blocks, functions and/or operations of the above disclosed methods.

The present disclosure provides implementations of non-transitory machine readable media storing instructions executable by a processor circuit, such as circuit 114, to control an apparatus, such as printing device 100 or printing device 200 described above, including a hand engagement interface including a manual actuator coupled to visual feedback circuitry, and a processor circuit coupled to the manual actuator and the visual feedback circuitry, wherein the instructions, when executed by the processor circuit, cause the processor circuit to practice any of the functions set forth herein. For example, such instructions can cause the processor circuit to detect manual user input to the manual actuator, and responsive to the manual user input, display selectable indicia via the visual feedback circuitry.

Thus, the present disclosure provides implementations of a printing device having a hand engagement interface that includes an actuator, such as a physical rotary dial, to select a modality of common single function printer/multifunction printer functions presented within a digital display as set forth herein that provides dynamic visual dialogue. The actuator itself can use single push button mechanics and a speaker, for example, to actuate both audible and haptic feedback to the user. Examples of the present disclosure permit a user to improve speed and accuracy of interaction with a smaller, lower cost display. A relatively high resolution display can be used that projects a simplified high contrast image that is optimized for visibility. The disclosed examples allow for much more information to be visible for the user, such as reasons relating to compliance to lower limit text sizes regulated for touchscreens, for example.

The processor circuit executing the machine readable instructions relating to the above described method(s) and devices can be a programmed processor or a specialized processor. As such, the processor circuitry described herein, including associated data structures, can be stored on a tangible or physical (broadly non-transitory) computer-readable storage device or medium, such as volatile memory, non-volatile memory, ROM memory, RAM memory, magnetic or optical drive, device or diskette and the like. More specifically, the computer-readable storage device may include any physical devices that provide the ability to store information such as data and/or instructions to be accessed by a processor or a computing device such as a computer or an application server.

Terms to exemplify orientation, such as upper/lower, left/right, top/bottom and above/below, may be used herein to refer to relative positions of elements as shown in the figures. It should be understood that the terminology is used for notational convenience and that in actual use the disclosed structures may be oriented different from the orientation shown in the figures. Thus, the terms should not be construed in a limiting manner.

The skilled artisan would recognize that various terminology as used in the Specification (including claims) connote a plain meaning in the art unless otherwise indicated. As examples, the specification describes and/or illustrates aspects useful for implementing the claimed disclosure by way of various structure, such as circuits or circuitry, as may be recognized in the figures or the related discussion as depicted by or using terms such as device, system, processing circuitry, and/or other examples.

Certain of these aspects may also be used in combination to exemplify how operational aspects have been designed, arranged. Whether alone or in combination with other such blocks (or circuitry including discrete circuit elements such as transistors, resistors etc.), these above-characterized aspects may be implemented in the form of circuits configured/coded by fixed design and/or by (re)configurable circuitry (such as, CPUs/logic arrays/controllers) and/or circuit elements to this end of the corresponding structure carrying out such operational aspects. In certain examples, such a programmable circuit refers to or includes a computer circuit, including memory circuitry for storing and accessing a set of program code to be accessed/executed as instructions and/or (re)configuration data to perform the related operation, as may be needed. Depending on the data-processing application, such instructions (and/or configuration data) can be configured for implementation in logic circuitry, with the instructions (via fixed circuitry, limited group of configuration code, or instructions characterized by way of object code and/or computer executable instructions) as may be stored in and accessible from a memory (circuit).

Based upon the above discussion and illustrations, those skilled in the art will readily recognize that various modifications and changes may be made to the various examples without strictly following the exemplified examples and applications illustrated and described herein. For example, methods as exemplified in the Figures may involve elements carried out in various orders, with aspects of the examples herein retained, or may involve fewer or more elements. Such modifications do not depart from the scope of various aspects of the disclosure, including aspects set forth in the claims.

What is claimed is:

1. A printing apparatus comprising:
a hand engagement interface including a manual actuator coupled to visual feedback circuitry, the manual actuator to receive a mechanical user input; and
a processor circuit coupled to the manual actuator and the visual feedback circuitry, wherein the processor circuit executes machine readable instructions to:
detect the mechanical user input to the manual actuator; and
responsive to the mechanical user input, render a dynamic display of selectable indicia to a user via the visual feedback circuitry, wherein the user is able to execute a control function of the printing apparatus by scrolling through and selecting an indicium from the selectable indicia.

2. The printing apparatus of claim 1, wherein:
the manual actuator includes a rotatable mechanical dial; and
the processor circuit executes the machine readable instructions to scroll the selectable indicia across a display screen in synchronization with corresponding rotational displacement of the rotatable mechanical dial.

3. The printing apparatus of claim 2, wherein the display screen is not responsive to touch input.

4. The printing apparatus of claim 2, wherein:
the rotatable mechanical dial is linearly displaceable along a direction that is parallel to a central rotational axis thereof such that user may depress the rotatable mechanical dial, and
the processor circuit executes the machine readable instructions to interpret depression of the rotatable mechanical dial as mechanical user input.

5. The printing apparatus of claim 4, wherein the rotatable mechanical dial is disposed near the display screen.

6. The printing apparatus of claim 5, wherein the display screen is disposed inside of the rotatable mechanical dial.

7. The printing apparatus of claim 5, wherein the display screen and rotatable mechanical dial are mounted on a pivot that permits the display to be tilted by a user.

8. The printing apparatus of claim 6, wherein the processor circuit executes the machine readable instructions to scroll the selectable indicia across the display screen in synchronization with rotation of the rotatable mechanical dial and to permit a user to select the indicium from the selectable indicia by depressing the rotatable mechanical dial.

9. The printing apparatus of claim 8, wherein the processor circuit executes machine readable instructions to scroll the selectable indicia across the display screen along a linear path responsive to rotation of the rotatable mechanical dial.

10. The printing apparatus of claim 8, wherein the processor circuit executes machine readable instructions to scroll the selectable indicia across the display screen along a curved path responsive to rotation of the rotatable mechanical dial.

11. The printing apparatus of claim 1, wherein:
the manual actuator includes a mechanically slidable switch; and
the processor circuit executes the machine readable instructions to cause the visual feedback circuitry to scroll the selectable indicia across a display screen in synchronization with corresponding linear sliding displacement of the mechanically slidable switch.

12. The printing apparatus of claim 1, wherein:
the manual actuator includes a touch pad interface; and
the processor circuit executes the machine readable instructions to move the selectable indicia across a display screen in synchronization with corresponding sliding touch of a user against the touch pad interface.

13. The printing apparatus of claim 1, wherein the processor circuit executes the machine readable instructions to permit a user to customize display settings of the selectable indicia.

14. A non-transitory machine readable medium storing instructions executable by a processor circuit to control a printing apparatus, the printing apparatus including a hand engagement interface including a manual actuator coupled to visual feedback circuitry, and a processor circuit coupled to the manual actuator and the visual feedback circuitry, wherein the instructions, when executed by said processor circuit, cause the processor circuit to:
detect manual user input to the manual actuator; and
responsive to the manual user input, display selectable indicia via the visual feedback circuitry.

15. A method of operating a printing apparatus, the printing apparatus including a hand engagement interface including a manual actuator coupled to visual feedback circuitry, and a processor circuit coupled to the manual actuator and the visual feedback circuitry, the method including:
detecting manual user input from a user by way of the manual actuator; and
responsive to the manual user input, displaying selectable indicia via the visual feedback circuitry.
